(19) United States
(12) Patent Application Publication
(10) Pub. No.: US 2010/0321921 A1
(43) Pub. Date: Dec. 23, 2010

(54) LED LAMP WITH A WAVELENGTH CONVERTING LAYER

(75) Inventor: John Ivey, Farmington Hills, MI (US)

Correspondence Address: YOUNG BASILE, 3001 WEST BIG BEAVER ROAD, SUITE 624, TROY, MI, 48084, US

(73) Assignee: ALTAIR ENGINEERING, INC., Troy, MI (US)

(21) Appl. No.: 12/821,406

(22) Filed: Jun. 23, 2010

Related U.S. Application Data
(60) Provisional application No. 61/219,625, filed on Jun. 23, 2009.
(60) Provisional application No. 61/317,798, filed on Mar. 26, 2010.

(51) Int. Cl. F21V 9/16; F21S 4/00

(52) U.S. Cl. 362/84; 362/225

(57) ABSTRACT

Disclosed herein are embodiments of replacement lights for conventional fluorescent tube lights for use in a conventional fluorescent fixture. One embodiment comprises a tubular housing, a circuit board disposed within the housing, a pair of end caps disposed on opposing ends of the tubular housing with at least one pin connector extending from each end cap, an array of LEDs arranged longitudinally along the circuit board, a number and spacing of the LEDs being such as to uniformly and fully occupy a space between the end caps, wherein at least one of the connectors is electrically connected to the LEDs and a wavelength-converting material in contact with at least a portion of the tubular housing. The wavelength-converting material is excited by transmitted light from the LEDs to produce visible light.

### CROSS REFERENCE TO RELATED APPLICATIONS

This application claims priority to U.S. Provisional Patent Applications with Ser. Nos. 61/219,625 filed on Jun. 23, 2009 and 61/317,798 filed on Mar. 26, 2010, both of which are incorporated herein by reference.

### TECHNICAL FIELD

The present invention relates to a light emitting diode (LED) based light for replacing a conventional fluorescent tube in a fluorescent light fixture having a wavelength conversion layer.

### BACKGROUND

Conventional fluorescent tubes are gradually being replaced by LED-based replacement lights in many applications. LED-based replacement lights have many advantages over conventional fluorescent tubes including, inter alia, longer operational life and reduced power consumption.

A single LED in an LED-based replacement light can only produce a single color, such as red, green, blue, amber, or yellow. To produce white light, light from LEDs can be converted to light spanning the visible spectrum by using color mixing. Color mixing can involve utilizing multiple LEDs in a device and varying the intensity of each LED to produce white light. However, color mixing may entail packing additional LEDs into one source and can require additional optics to mix the light from the multiple LEDs, which can introduce extra losses and increase the cost of the replacement light.

### BRIEF SUMMARY

Disclosed herein are embodiments of replacement lights for conventional fluorescent tube lights for use in a conventional fluorescent fixture. One embodiment comprises a tubular housing, a circuit board disposed within the housing, a pair of end caps disposed on opposing ends of the tubular housing with at least one pin connector extending from each end cap, an array of LEDs arranged longitudinally along the circuit board, a number and spacing of the LEDs being such as to uniformly and fully occupy a space between the end caps, wherein at least one of the connectors is electrically connected to the LEDs and a wavelength-converting material in contact with at least a portion of the tubular housing. The wavelength-converting material is excited by transmitted light from the LEDs to produce visible light.

Another embodiment disclosed herein of a replacement light for a conventional fluorescent tube light for use in a conventional fluorescent fixture comprises a tubular housing having a back portion and a front portion attached to the back portion, a circuit board disposed along the back portion of the tubular housing, a pair of end caps disposed on opposing ends of the tubular housing with at least one pin connector extending from each end cap, an array of LEDs arranged longitudinally along the circuit board opposite the back portion, a number and spacing of the LEDs being such as to uniformly and fully occupy a space between the end caps, wherein at least one of the connectors is electrically connected to the LEDs and a wavelength-converting layer in contact with at least a portion of the front portion of the tubular housing. The wavelength-converting material is excited by transmitted light from the LEDs to produce visible light.

### BRIEF DESCRIPTION OF THE DRAWINGS

The description herein makes reference to the accompanying drawings wherein like reference numerals refer to like parts throughout the several views, and wherein:

FIG. 1 is a perspective view of a LED-based replacement light in accordance with one embodiment of the invention and a fluorescent fixture;

FIG. 2 is a cross-section view of the LED-based replacement light of FIG. 1 at a position similar to line A-A;

FIG. 3 is a cross-section view of another embodiment of the LED-based replacement light at a position similar to line A-A;

FIG. 4 is a cross-section view of another LED-based replacement light in accordance with an embodiment of the invention along a line similar to line A-A in FIG. 1; and

FIG. 5 is a perspective view of a LED-based replacement light in accordance with another embodiment of the invention and a fluorescent fixture.

### DETAILED DESCRIPTION

The embodiments disclosed herein can provide a separate wavelength-conversion layer remote from the LEDs themselves. This provides for operation of the wavelength-conversion coating or wavelength-converting material at a lower temperature and light intensity than would be possible if it were packaged with the LED chips. This separation allows a phosphor layer to also function as a diffusing material to obscure the bright points of light produced by the LEDs and spread the light from the tube, without introducing extra light losses that would be produced by using a single-purpose diffusing layer in addition to a phosphor contained in the LED package.

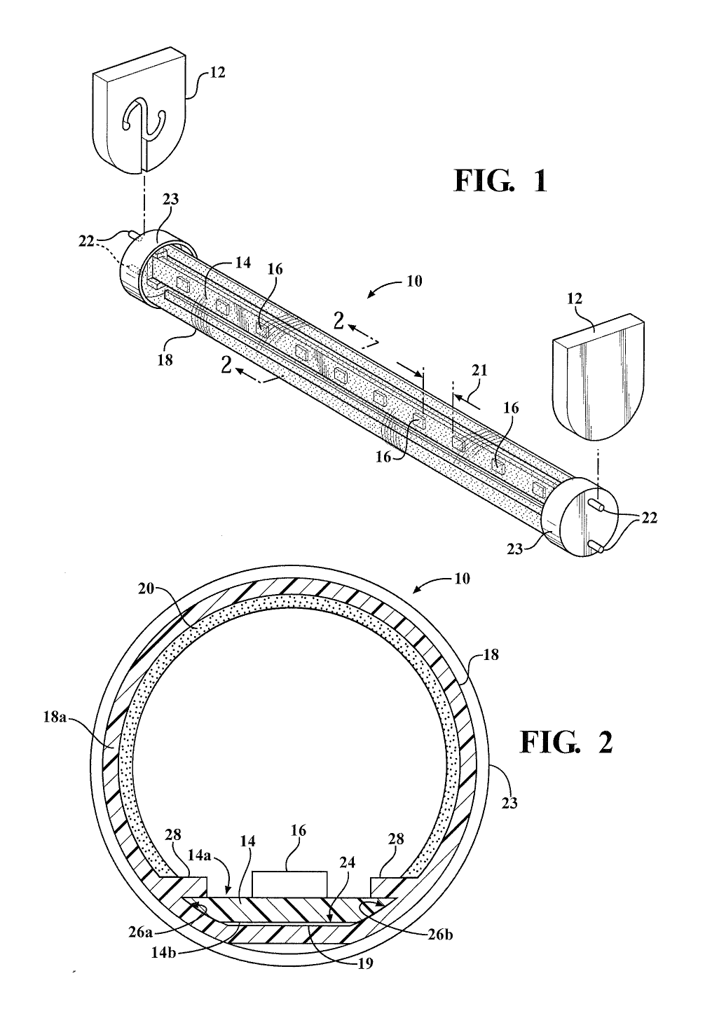

FIGS. 1 and 2 illustrate an LED-based replacement light 10 according to the embodiments discloses herein for replacing a conventional fluorescent light tube in a fluorescent fixture 12. The light 10 can include a circuit board 14, multiple UV/blue LEDs 16 (hereafter LEDs), a tubular housing 18 at least partially defined by a high-dielectric translucent portion and coated by a wavelength-converting layer 20, and bi-pin electrical connectors 22 affixed to plastic end caps 23.

The circuit board 14 can have a LED-mounting side 14a and a primary heat transferring side 14b opposite the LED-mounting side 14a. The circuit board 14 may be made in one piece or in longitudinal sections joined by electrical bridge connectors. The circuit board 14 can be one on which metalized conductor patterns can be formed in a process called “printing” to provide electrical connections from the connectors 22 to the LEDs 16 and between the LEDs 16 themselves. An insulative board is typical, but alternatively, other circuit board types, e.g., metal core circuit boards, can be used.

The LEDs 16 can be mounted at predetermined intervals 21 along the length of the circuit board 14 to uniformly emit light through a portion the tube 18. LEDs 16 can emit electromagnetic radiation in the UV range, the blue range or in both the UV and blue ranges of the electromagnetic spectrum.

The spacing 21 between LEDs 16 along the circuit board 14 can be a function of the length of the tube 18, the amount of light desired, the wattage of the LEDs 16 or the viewing angle of the LEDs 16. Thus, for example, if the light 10 is 48 inches long, the number of LEDs 16 may vary from about thirty to sixty such that the light 10 outputs approximately 3,000 lumens, and the spacing 21 between the LEDs 16 varies accordingly. The arrangement of LEDs 16 on the circuit board 14 is such as to substantially fill the entire space between the end caps 23.

End caps 23 carrying bi-pin connectors 22 are attached to each longitudinal end of the tube 18 for physical and electrical connection of the light 10 to the fixture 12. Since the LEDs 16 in the present embodiment are directionally oriented, the light 10 should be installed at a proper orientation relative to a space to be illuminated to achieve a desired illumination effect. While the end caps 22 are shown as cup-shaped structures that slide over longitudinal ends of the tube 18, alternative end caps that fit into the tube 18 can be used in place of the illustrated cup-shaped end caps 22. Also, two of the pins 22 may be “dummy pins” for physical but not electrical connection to the fixture 12 thereby permitting only the other two pins 22 to be active. Bi-pin connectors 22 are compatible with many fluorescent fixtures 12, though end caps 23 with alternative electrical connectors, e.g., single pin end caps, can be used in place of end caps 22 carrying bi-pin connectors 23 when desired.

Still referring to FIGS. 1 and 2, the tube 18 can include a longitudinally extending flat interior surface 24 for supporting the circuit board 14. The surfaces 26a and 26b of the tube 18 on either side of the circuit board 14 are optionally contoured to the sides of the circuit board 14. The exterior of the tube 18 can optionally be D-shaped, with the exterior flat portion corresponding to the location of the flat interior surface 24. The tube 18 can be formed of polycarbonate, acrylic, glass, or another high-dielectric light transmitting material. As used herein, the term “high-dielectric” means a material which has a low conductivity to direct current; e.g., an insulator.

The tube 18 can include optional tabs 28 for securing the circuit board 14. The tabs 28 can project from the tube 18 on opposite sides of the circuit board 14 and contact the LED-mounting side 14a of the circuit board 14. The tabs 28 can be formed integrally with the tube 18 by, for example, extruding the tube 18 to include the tabs 28. Each tab 28 can extend the entire length of the tube 18, though a series of discrete tabs 28 can alternatively be used to secure the circuit board 14.

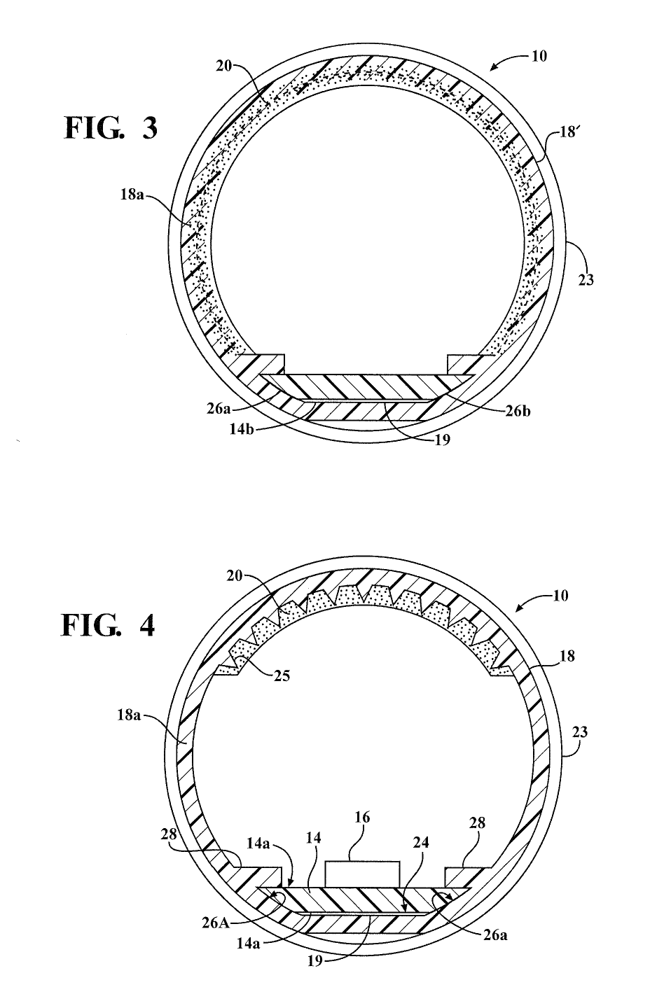

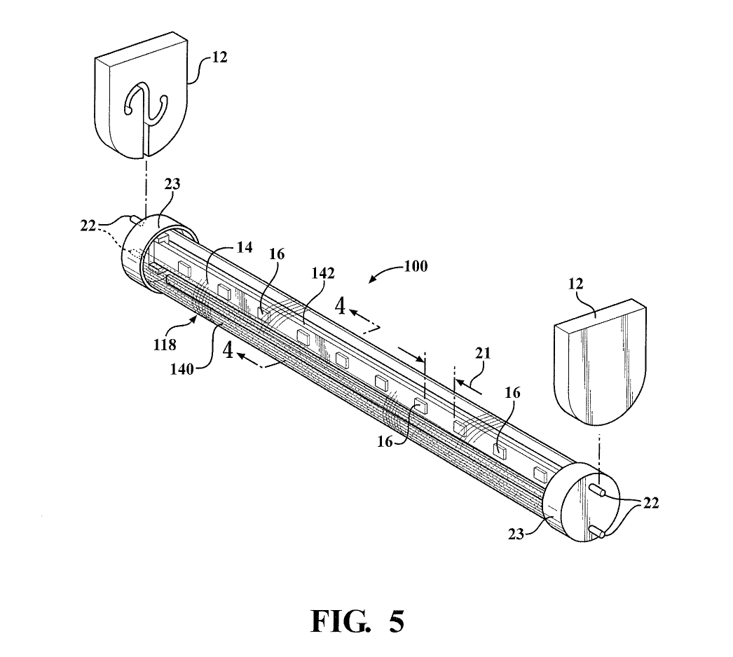

The wavelength-converting layer 20 can be placed on an inner surface 18a of the tube 18. The wavelength-converting layer 20 can be placed on the entire inner surface 18a of the tube 18, or the wavelength-converting layer 20 can be placed along a portion of the inner surface 18a of the tube 18 through which a majority of light passes. The wavelength-converting layer 20 can be composed of a transparent resin containing one or more phosphors such as a mono-, bi-, tri-phosphor blend or any other blend as desired or required. If multiple phosphors are used, distinct colors such as yellow, green, red and the like can be applied to several layers of wavelength-converting layer 20. The phosphor may emit a white or yellow light or if multiple phosphors are used, the phosphor may emit different colors which can be combined to produce a resulting white or yellow light. Alternatively, as shown in FIG. 3, instead of forming a separate layer, the wavelength-converting material could be incorporated into part or all of the material of the tube 18′, for example by molding, extrusion or co-extrusion.

The color and number of the single or multiple phosphors may be dependent on the type of LEDs 16. Thus, for example, a light 10 may contain blue LEDs, such as InGAN blue LEDs, and a wavelength-converting material containing yellow phosphor, such as YAG:Ce. Blue light emitted from the blue LED is used to excite the yellow phosphor, producing approximately white light. Alternatively, a white LED, formed using a blue LED chip and a phosphor emitting a high color temperature white light, could be used as the light source, and a quantum dot wavelength conversion material used as the active material in the wavelength-converting layer 20 to convert the light to a lower color temperature.

Other combinations of different LEDs and different wavelength-converting layers 20 are available as desired or as required.

In the above-described light 10, when emission takes place from the LEDs 16 and light is emitted, the light is directed to the wavelength-converting layer 20. The blue, UV or blue and UV light then collides with the wavelength-converting layer 20 and excites the phosphor contained therein.

Wavelength-converting layer 20 can also act as a free diffuser. Wavelength-converting layer 20 can include, for example, a distribution of transparent particles or air bubbles. The transparent particles or air bubbles can repeatedly refract or diffuse the light emitted from LEDs 16, which can aid in more uniformly distributing the light from the LEDs. Further, wavelength-converting layer 20 may have a high coefficient of thermal conductivity. As a result, the wavelength-converting material can act as a heat sink by dissipating heat produced by the LEDs 16.

FIG. 3 illustrates the tube 18 containing light diffracting structures, such as longitudinally extending ridges 25 formed on the interior of the tube 18. Longitudinally extending ridges 25 assist in uniformly distributing light to the environment to be illuminated in order to replicate the uniform light distribution of conventional fluorescent bulbs the light 10 is intended to replace. Alternatively, light diffracting structures can include dots, bumps, dimples, and other uneven surfaces formed on the interior or exterior of the tube 18. The light diffracting structures can be formed integrally with the tube 18, for example, by molding or extruding, or the structures can be formed in a separate manufacturing step such as surface roughening. The light diffracting structures can be placed around an entire circumference of the tube 18, or the structures can be placed along an arc of the tube 18 through which a majority of light passes. In addition or alternative to the light diffracting structures, a light diffracting film can be applied to the exterior of the tube 18 or placed in the tube 18, or the material from which the tube 18 is formed can include light diffusing particles.

The wavelength-converting layer 20 can be placed on the longitudinally extending ridges 25 or alternatively, can be placed on the entire inner surface 18a of the tube 18. When light is emitted from the LEDs 16, the light is directed to the wavelength-converting layer 20. The blue, UV or blue and UV light then collides with the wavelength-converting layer 20 and excites the phosphor contained therein. The white or yellow light emitted from the phosphor can pass through longitudinally extending ridges 25, which in turn, provides a more even distribution of light to the environment to be illuminated.

FIG. 4 illustrates an LED-based replacement light 100 according to another embodiment of the present invention for replacing a conventional fluorescent light tube in the fluorescent fixture 12. Features in this embodiment, which are similar to features already discussed with reference to the embodiment of FIGS. 1-2, are referenced using the same numerals and are not discussed in further detail. Unlike the embodiment illustrated in FIGS. 1-2, this embodiment contains a housing 118 with a back portion 140 with a semicircular cross-section that holds the circuit board 14 on which the LEDS 16 are mounted and electrically interconnected. A transparent or translucent front portion 142 with a semicircular cross-section, attaches to the back portion 140 to enclose circuit board 14 and LEDs 16 and circuit board.

In this embodiment, the back portion 120 can be made of a metal such as aluminum to assist in heat dissipation from the LEDs 16. In other embodiments, the back portion 120 can be made of any other suitable material. For example, back portion 120 can be made of steel. Further, embodiments of the present invention are not limited to a back portion that is semicircular in cross-section. For example, in other embodiments, the back portion can be of a rectangular or triangular cross-section or any other suitable cross-section.

Front portion 142 can made of high-dielectric material such as an acrylic plastic. In other embodiments, the front portion 142 can be made of any other suitable material. For example, the front portion 142 can be made of glass. Embodiments of the present invention are not limited to a front portion that is semicircular in cross-section. For example, in other embodiments, the front portion can be of a rectangular or triangular cross-section or any other suitable cross-section.

Like the embodiment of FIGS. 1 and 2, front portion 142 is coated by wavelength-converting layer 20. The wavelength-converting layer 20 can be placed on an inner surface of the front portion 142. The wavelength-converting layer 20 can be placed on the entire inner surface 18a of the tube 18, or the wavelength-converting layer 20 can be placed along a portion of the inner surface 18a of the tube 18 through which a majority of light passes.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A replacement light for a conventional fluorescent tube light for use in a conventional fluorescent fixture comprising:
a tubular housing;
a circuit board disposed within the housing;
a pair of end caps disposed on opposing ends of the tubular housing with at least one pin connector extending from each end cap;
an array of LEDs arranged longitudinally along the circuit board, a number and spacing of the LEDs being such as to uniformly and fully occupy a space between the end caps, wherein at least one of the connectors is electrically connected to the LEDs; and
a wavelength-converting material in contact with at least a portion of the tubular housing, wherein the wavelength-converting material is excited by transmitted light from the LEDs to produce visible light.

2. The replacement light of claim 1, wherein the tubular housing has an interior surface, and wherein the wavelength-converting material is a layer formed on at least a portion of the interior surface through which a majority of the transmitted light passes.

3. The replacement light of claim 2, wherein the wavelength-converting material is a layer formed on the entire interior surface.

4. The replacement light of claim 1, wherein the wavelength-converting material comprises a transparent resin containing one or more phosphors.

5. The replacement light of claim 4, wherein the wavelength-converting material is formed as layers on at least a portion of an interior surface of the tubular housing, each layer comprising a phosphor of a distinct color.

6. The replacement light of claim 1, wherein the wavelength converting material is incorporated into a material of the tubular housing prior to forming the tubular housing.

7. The replacement light of claim 1, wherein the LEDs are blue LEDs and the wavelength-converting material comprises yellow phosphor.

8. The replacement light of claim 1, wherein the LEDs are white LEDs formed from blue LEDs and a phosphor emitting a high color temperature white light, and wherein the wavelength-converting material comprises a quantum dot wavelength conversion material.

9. The replacement light of claim 1, wherein the wavelength-converting material is a diffuser comprised of transparent particles.

10. The replacement light of claim 1, wherein the wavelength-converting material is a heat sink comprised of a material with a high coefficient of thermal conductivity.

11. The replacement light of claim 1 further comprising light diffracting structures formed on at least a portion of an interior surface of the tubular housing, wherein the wavelength-converting material forms a coating on the light diffracting structures.

12. The replacement light of claim 1 further comprising tabs projecting from an interior surface of the tubular housing and configured to contact an LED-mounting side of the circuit board.

13. A replacement light for a conventional fluorescent tube light for use in a conventional fluorescent fixture comprising:
a tubular housing having a back portion and a front portion attached to the back portion;
a circuit board disposed along the back portion of the tubular housing;
a pair of end caps disposed on opposing ends of the tubular housing with at least one pin connector extending from each end cap;
an array of LEDs arranged longitudinally along the circuit board opposite the back portion, a number and spacing of the LEDs being such as to uniformly and fully occupy a space between the end caps, wherein at least one of the connectors is electrically connected to the LEDs; and
a wavelength-converting layer in contact with at least a portion of the front portion of the tubular housing, wherein the wavelength-converting material is excited by transmitted light from the LEDs to produce visible light.

14. The replacement light of claim 13, wherein the wavelength-converting material comprises a transparent resin containing one or more phosphors.

15. The replacement light of claim 13, wherein the wavelength-converting material is formed as layers on at least a portion of an interior surface of the front portion, each layer comprising a phosphor of a distinct color.

16. The replacement light of claim 13, wherein the wavelength converting material is incorporated into a material of the front portion of the tubular housing prior to forming the front portion of the tubular housing.

17. The replacement light of claim 13, wherein the LEDs are blue LEDs and the wavelength-converting material comprises yellow phosphor.

18. The replacement light of claim 13, wherein the LEDs are white LEDs formed from blue LEDs and a phosphor emitting a high color temperature white light, and wherein the wavelength-converting material comprises a quantum dot wavelength conversion material.

19. The replacement light of claim 13, wherein the wavelength-converting material is a diffuser comprised of transparent particles.

20. The replacement light of claim 13 further comprising light diffracting structures formed on at least a portion of an interior surface of the front portion of the tubular housing, wherein the wavelength-converting material forms a coating on the light diffracting structures.
